(19) United States
(12) Patent Application Publication
(10) Pub. No.: US 2012/0188848 A1
(43) Pub. Date: Jul. 26, 2012

(54) ULTRASONIC UNDERWATER PAGER

(75) Inventors: MIHEUNG CHOE, KUNPO (KR); KYOUNGWON KIM, KUNPO (KR)

(73) Assignee: KYUNGWON FERRITE INC. CO., LTD., Shiheung-si (KR)

(21) Appl. No.: 13/179,576

(22) Filed: Jul. 11, 2011

(30) Foreign Application Priority Data
Jan. 24, 2011 (KR) 10-2011-0006806

(51) Int. Cl. H04B 11/00; A45F 5/00

(52) U.S. Cl. 367/131; 224/269

(57) ABSTRACT

Disclosed herein is an underwater pager configured such that a hole is not formed in the outer wall of a casing. The ultrasonic underwater pager includes an ultrasonic transducer for transmitting or receiving ultrasonic signals. An electronic circuit unit generates an ultrasonic signal and analyzes a received ultrasonic signal. A switch unit is switched using a magnetic phenomenon and is configured to supply power to the electronic circuit unit and transmit external commands to the electronic circuit unit. A watertight casing is configured such that the ultrasonic transducer, the electronic circuit unit, and the switch unit are installed in the watertight casing, the ultrasonic transducer being installed in a raised position in the watertight casing using a molding process. A magnet is attached to a rubber cover connected to an outside of the watertight casing, and is configured to switch on/off the switch unit using a magnetic phenomenon.

### BACKGROUND OF THE INVENTION

1. Field of the Invention

The present invention relates, in general, to pagers, and, more particularly, to an ultrasonic underwater pager, which assigns a group identification code and an individual identification code under the water and then transmits or receives signals to or from a specific group or a specific individual person while enabling the structure of the pager to be simplified and facilitating the propagation of ultrasonic waves.

2. Description of the Related Art

Conventional ultrasonic communication devices were developed mainly to perform voice communication underwater, and thus signals were able to be received based on one-to-one communication or one-to-many communication.

Such an ultrasonic communication device has used a method of transferring voice signals to a Single Side-Band (SSB) frequency band and radiating the voice signals into the water through an ultrasonic transducer.

However, such an ultrasonic communication device using voice is problematic because the structure thereof is complicated compared to the communication schemes in which simple messages are exchanged based on analog communication, thus increasing the cost of manufacturing the ultrasonic communication device.

Further, an ultrasonic communication device is disadvantageous in that since it is based on voice communication, communication is possible only when a voice can be heard. Moreover, a switch for driving an ultrasonic communication device is installed. Such a switch is implemented as a structure in which a hole is formed in the outer wall of a watertight casing and the switch is installed in the hole, and thus there is a fundamental difficulty when achieving watertightness.

Accordingly, there is required in the art the development of a technology for complementing watertightness by means of the improvement of a switch structure, identifying the mutual locations of users based on addresses under the water, rather than based on analog-based voice communication, and performing meaningful communication between specific groups or between specific individual persons.

### SUMMARY OF THE INVENTION

Accordingly, the present invention has been made keeping in mind the above problems occurring in the prior art, and an object of the present invention is to provide an ultrasonic underwater pager, which has a simplified structure so that the pager is watertight and can be used underwater without a hole being formed in the outer wall of a casing, and which has a structure in which an ultrasonic transducer is installed in a raised position in the casing using a molding process so that the propagation of ultrasonic waves is facilitated.

Another object of the present invention is to provide an ultrasonic underwater pager, which assigns a group identification code and an individual identification code under the water, thus transmitting or receiving signals to or from a specific group or a specific individual person.

A further object of the present invention is to provide an ultrasonic underwater pager, which assigns a group identification code and an individual identification code, which correspond to an independent address, to a transmission signal, thus transmitting or receiving meaningful signals between a plurality of users and a specific user who are equipped with the underwater pagers under the water.

Yet another object of the present invention is to provide an ultrasonic underwater pager, which can provide a warning related to the results of communication in the form of sound or light using a buzzer, and can perform power switching using the magnetic phenomenon between a magnet and a reed switch, wherein instead of the buzzer, a vibration motor capable of generating a vibration can also be used.

Objects of the present invention are not limited to the above-described objects, and other objects that are not described will be more clearly understood by those skilled in the art from the following detailed description.

In order to accomplish the above objects, the present invention provides an ultrasonic underwater pager, including an ultrasonic transducer for transmitting or receiving ultrasonic signals; an electronic circuit unit for generating an ultrasonic signal having a predetermined address and analyzing a received ultrasonic signal; a switch unit switched using a magnetic phenomenon and configured to supply power to the electronic circuit unit and transmit external commands to the electronic circuit unit; a watertight casing configured such that the ultrasonic transducer, the electronic circuit unit, and the switch unit are installed in the watertight casing, the ultrasonic transducer being installed in a raised position in the watertight casing using a molding process, thus facilitating propagation of ultrasonic waves; and a magnet attached to a rubber cover connected to an outside of the watertight casing, and configured to switch on/off the switch unit using a magnetic phenomenon.

Preferably, the electronic circuit unit may include a digital signal control unit for generating a transmission signal and analyzing a received signal; a switching driving unit for receiving a switching signal and a transmission trigger signal from the digital signal control unit, and performing low-current switching on an initially generated transmission signal; a high-current switching unit for performing high-current switching on the low-current switched transmission signal; a matching unit for increasing switching efficiency of the high-current switching unit and enabling maximum power to be transferred; a diode coupling unit for transferring the transmission signal which has been high-current switched by the high-current switching unit to the ultrasonic transducer, and receiving the ultrasonic signal from the ultrasonic transducer; a received signal amplification unit for filtering and amplifying the signal received from the diode coupling unit; an envelope detector for detecting an envelope of the amplified signal; and a power control circuit for controlling supply of external power.

Preferably, the switch unit may include a reed switch switched according to a location of the magnet; and a switch input circuit for allowing current to flow and power to be output when the reed switch is switched on, and for allowing current to continuously flow and power to be output even if the reed switch is switched off when a digital signal is applied by the digital signal control unit.

Preferably, the address may include a group identification code required to identify a group and composed of predetermined bits; and an individual identification code required to identify each individual device and composed of predetermined bits.

Preferably, the ultrasonic underwater pager may further include an information display window for displaying transmission/reception addresses, an alarm, and states of the electronic circuit unit.

Preferably, the ultrasonic underwater pager may further include a connection belt formed on both side surfaces of the watertight casing and used to allow the ultrasonic underwater pager to be attached to a human body or an object.

### BRIEF DESCRIPTION OF THE DRAWINGS

The above and other objects, features and advantages of the present invention will be more clearly understood from the following detailed description taken in conjunction with the accompanying drawings, in which:

FIGS. 1A to 1C are views showing an ultrasonic underwater pager according to an embodiment of the present invention;

FIG. 2 is a sectional view showing the internal construction of the ultrasonic underwater pager according to an embodiment of the present invention;

FIG. 3 is a functional block diagram showing the internal construction of the ultrasonic underwater pager according to an embodiment of the present invention;

FIG. 4 is a diagram showing the switch unit of the ultrasonic underwater pager according to an embodiment of the present invention;

FIG. 5 is a conceptual diagram showing an operation using a plurality of ultrasonic underwater pagers according to an embodiment of the present invention;

FIG. 6 is a diagram showing examples of identification codes used by the ultrasonic underwater pager according to the present invention; and

FIGS. 7A to 7C are diagrams showing examples of the digital information representation system of the ultrasonic underwater pager according to the embodiment of the present invention.

### DESCRIPTION OF THE PREFERRED EMBODIMENTS

Hereinafter, embodiments of the present invention will be described in detail with reference to the attached drawings. If in the specification, detailed descriptions of well-known functions or configurations may unnecessarily make the gist of the present invention obscure, the detailed descriptions will be omitted, and repetitive descriptions will also be omitted.

In the present specification, the case where any one first component “transmits” data or signals to another second component means that the first component may transmit the data or signals to the second component either directly or via at least one third component.

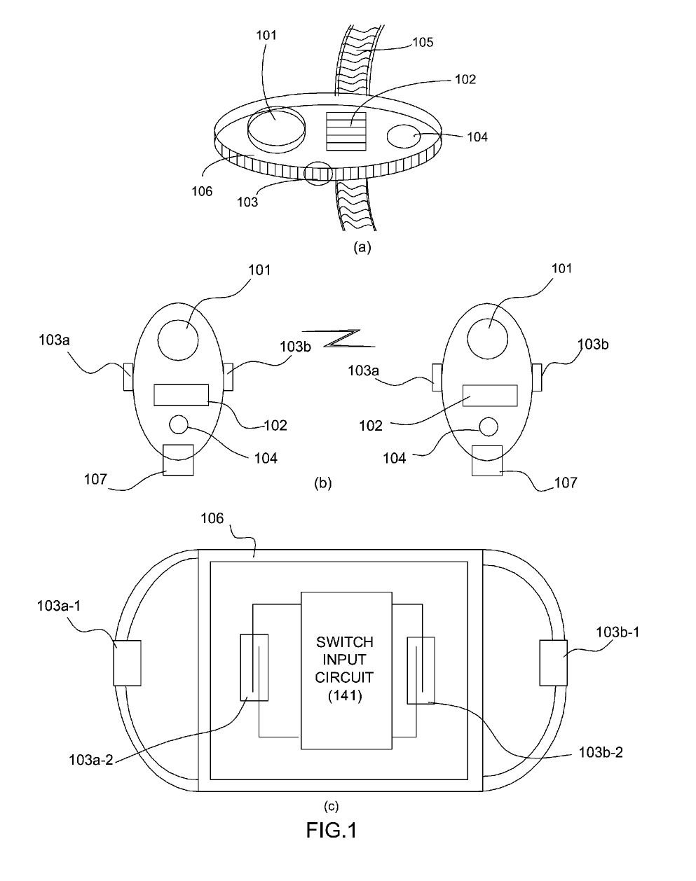

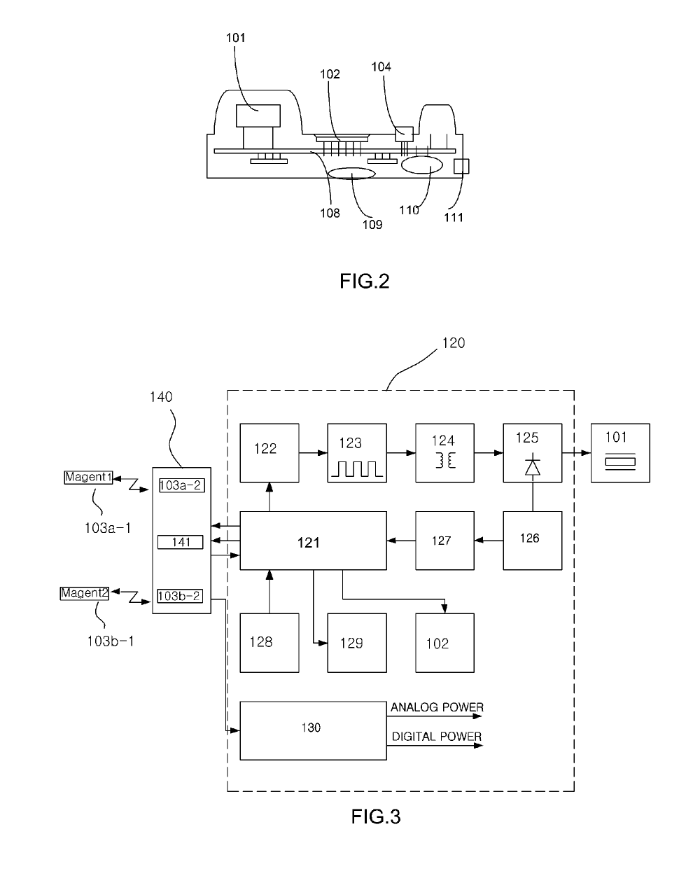

FIG. 1 is a view showing an ultrasonic underwater pager according to an embodiment of the present invention, and FIG. 2 is a sectional view showing the internal construction of the ultrasonic underwater pager according to an embodiment of the present invention. Referring to FIGS. 1 and 2, an ultrasonic underwater pager 100 includes an ultrasonic transducer 101, an information display window 102, a push switch 103, a buzzer 104, a connection belt 105, a watertight casing 106, a Printed Circuit Board (PCB) 108, a vibration motor 109, a battery 110, and a charging terminal 111.

The ultrasonic transducer 101 is a component for transmitting or receiving ultrasonic waves. The ultrasonic transducer 101 is basically implemented as a ceramic element and matches its frequency to a center frequency. Therefore, when the ultrasonic transducer 101 is used, at least two users may form a single group and may perform group communication, and both a group identification code (GID) and an individual identification code (IID) are used so that group communication and individual communication can be selectively performed.

When the ultrasonic transducer 101 functions as a transmitting end, it uses a power amplification technology which applies a switching technology, and enables the final ultrasonic signal to be transmitted as a sine wave signal. In this case, the ultrasonic transducer 101 modulates an electrical signal having a group identification code (GID) and an individual identification code (IID) into a transmission signal under the control of the control unit, and then transmits an ultrasonic signal. When the ultrasonic transducer 101 functions as a receiving end, it receives an externally applied ultrasonic signal.

The information display window 102 may display a group identification code (GID), an individual identification code (IID), transmission/reception states, information about the residual capacity of the battery 110, etc.

The push switch 103 is a switch required to perform functions such as the ON/OFF operation of power of the ultrasonic underwater pager, address setting, and alarm setting. In the present embodiment, the push switch 103 is divided into a functional switch 103a and an alarm switch 103b, but it may be configured in different manners when being designed depending on required functions.

Meanwhile, the functional switch 103a includes a magnet 103a-1 formed on the outside of the watertight casing 106 which will be described later and a read switch 103a-2 formed inside the watertight casing 106, and may perform functions such as the ON/OFF operation of power and the setting of addresses using a switch input circuit 141. Further, according to the input given to the functional switch 103a, the group identification code (GID), the individual identification code (IID), transmission/reception states, and information about the residual capacity of the battery 110 can be displayed on the information display window 102. Further, similarly to the functional switch 103a, the alarm switch 103b is also formed to include a magnet 103b-1 and a reed switch 103b-2, and performs the above alarm function and operation, by interacting with the switch input circuit 141.

Here, both side surfaces of the watertight casing 106 are connected to rubber covers 103a-3 and 103b-3 to which the magnets 103a-1 and 103b-1 are respectively attached. Accordingly, the reed switches 103a-2 and 103b-2 can be switched by the magnetic phenomenon of the magnets 103a-1 and 103b-1. The watertight casing 106 can be structurally watertight without requiring external machining.

The buzzer 104 is a component that can be additionally used, and is used to represent information, indicating that the same signal as the group identification code (GID) which is an address code identical to that of its own device is currently being received, in the form of sound or light under the control of the control unit. Depending on the circumstances, the underwater pager of the present invention may be designed such that a vibration is generated by a vibration motor.

The connection belt 105 is formed on both side surfaces of the watertight casing 106 of the ultrasonic underwater pager, and is used to allow the underwater pager to be attached to a human body, such as a wrist, a waist or an ankle, or an object.

The watertight casing 106 is made of a plastic material and is configured such that mechanically formed holes for making an external connection are not formed so as to realize waterproofing. As shown in the drawing, the watertight casing 106 has a structure in which the ultrasonic transducer 101 is installed in a raised position in the watertight casing 106 using a molding process, thus facilitating the propagation of ultrasonic waves under the water.

The PCB 108 is used to electrically connect the ultrasonic transducer 101, the information display window 102, the buzzer 104, the vibration motor 109, the battery 110, and the charging terminal 111 to one another.

Moreover, the ultrasonic underwater pager 100 includes the vibration motor 109 for providing a warning using vibrations depending on the reception of a reception signal, and is supplied with external power from the charging terminal 111 to charge the battery 110.

FIG. 3 is a functional block diagram showing the internal construction of the ultrasonic underwater pager according to an embodiment of the present invention. Referring to FIGS. 1 to 3, the ultrasonic underwater pager includes an ultrasonic transducer 101, an electronic circuit unit 120, a switch unit 140, a watertight casing 106, and magnets 103a-1 and 103b-1. The ultrasonic transducer 101 transmits or receives ultrasonic signals. The electronic circuit unit 120 generates an ultrasonic signal having a predetermined address, and analyzes a received ultrasonic signal. The switch unit 140 is switched by a magnetic phenomenon and is configured to supply power to the electronic circuit unit and to transmit external commands to the electronic circuit unit. The watertight casing 106 is configured such that the ultrasonic transducer 101, the electronic circuit unit 120, and the switch unit 140 are installed in the watertight casing 106, and such that the ultrasonic transducer 101 is installed in a raised position in the watertight casing 106 using a molding process, thus facilitating the propagation of ultrasonic waves. The magnets 103a-1 and 103b-1 switch on/off the switch unit 140 using a magnetic phenomenon.

The electronic circuit unit 120 includes a digital signal control unit 121, a switching driving unit 122, a high-current switching unit 123, a matching unit 124, a diode coupling unit 125, a received signal amplification unit 126, an envelope detector 127, and a power control circuit 130. Further, the electronic circuit unit 120 may additionally include a battery residual capacity detection unit 128, a buzzer control unit 129, and an information display window 102.

A transmission procedure is performed in such a way that a transmission signal initially generated by the digital signal control unit 121 is low-current switched by the switching driving unit 122 and is then high-current switched by the high-current switching unit 123, and that a resulting transmission signal is transferred from the matching unit 124 to the ultrasonic transducer 101, thus enabling ultrasonic waves to be radiated by the ultrasonic transducer 101.

In contrast, a reception procedure is performed in such a way that a reception signal received by the ultrasonic transducer 101 is amplified and filtered by the received signal amplification unit 126 via the diode coupling unit 125, and that a resulting signal detected by the envelope detector 127 is compared to a predetermined magnitude by a comparator (not shown) and is determined to be a reflected wave when the magnitude of the detected signal is equal to or greater than the predetermined magnitude. Accordingly, the digital signal control unit 121a performs a procedure for checking the address.

Hereinafter, transmission and reception procedures for each component will be described in detail.

The digital signal control unit 121 performs control such that it generates a group identification code (GID) and an individual identification code (IID) which are specific address signals, and transmits them to another ultrasonic underwater pager having a specific address that includes another GID or another IID by reflecting ultrasonic waves into the water through the ultrasonic transducer 101, and such that it receives ultrasonic signals, input at its address, through the ultrasonic transducer 101.

That is, the digital signal control unit 121 broadcasts the GID and IID of one ultrasonic underwater pager, which correspond to a unique address indicating a transmitting end, and the GID and IID of another ultrasonic underwater pager, which correspond to a destination address indicating a receiving end, by controlling the ultrasonic transducer 101.

The digital signal control unit 121 transmits a transmission signal, and a switching signal and a transmission trigger signal which have the same frequency as the transmission signal, to the switching driving unit 122.

The switching driving unit 122 receives the switching signal and the transmission trigger signal from the digital signal control unit 121, performs low-current switching on the transmission signal initially generated by the digital signal control unit 121, and transmits the low-current switched transmission signal to the high-current switching unit 123.

The high-current switching unit 123 performs high-current switching on the low-current switched transmission signal, and transmits the high-current switched transmission signal to the transformer of the matching unit 124.

The matching unit 124 performs matching so that the maximum power is transferred by setting the ratio of the ultrasonic transducer 101 to the secondary side of the transformer of the matching unit 124 to a suitable level in order to improve the switching efficiency of the high-current switching unit 123.

The diode coupling unit 125 functions to implement a transmission mode and a reception mode by causing a high level voltage, obtained when the transmission signal that is high-current switched by the high-current switching unit 123 is transmitted, to pass therethrough and to be connected to the ultrasonic transducer 101, and by causing a low level voltage, obtained when the reception signal is received, to be connected to the received signal amplification unit 126.

The received signal amplification unit 126 performs noise removal filtering and signal amplification on the signal received from the ultrasonic transducer 101 when the signal is received, and transmits the amplified signal to the envelope detector 127.

The envelope detector 127 detects the envelope of the signal amplified by the received signal amplification unit 126, and transmits the detected envelope to a comparator (not shown) for determining whether a signal has been received. Meanwhile, the signal that has passed through the comparator (not shown) from the envelope detector 127 is transmitted to the digital signal control unit 121, and undergoes a reception algorithm.

Meanwhile, the reception algorithm of the digital signal control unit 121 is configured to differentiate the interval between transmission signals from the interval between reception signals and to obtain a specific address. A digital signal conversion technique is used as such an algorithm implementation method.

The battery residual capacity detection unit 128 is connected to the battery 110, and is configured to detect the residual capacity of the battery 110 and transmit information about the residual capacity to the digital signal control unit 121. Accordingly, the digital signal control unit 121 displays the information about the detected residual capacity of the battery 110 on the information display window 102.

The buzzer control unit 129 is connected to the buzzer 104 and is configured to control the buzzer 104.

The power control circuit 130 is connected to the digital signal control unit 121 and the switch unit 140, and performs control such that power supplied by the battery 110 or the charging terminal 111 is provided to the power circuit unit 120.

The switch unit 140 is connected to the digital signal control unit 121 and the power control circuit 130. Hereinafter, a description will be made on the basis of the functional switch 103a for the sake of description, but it is apparent to those skilled in the art that the present invention may also be modified and applied to the alarm switch 103b.

The ultrasonic underwater pager includes the watertight casing 106 entirely made of a plastic material and provided with no mechanically formed holes for making an external connection so as to prevent water from leaking in when in the water. Further, the ultrasonic underwater pager enables the reed switch 103a-2 of the switch unit 140 to be switched on/off using a magnetic phenomenon between the reed switch 103a-2 and the magnet 103a-1.

That is, the ultrasonic underwater pager is designed such that the reed switch 103a-2 is disposed in the watertight casing 106 and is switched according to the variation in an external magnetic force.

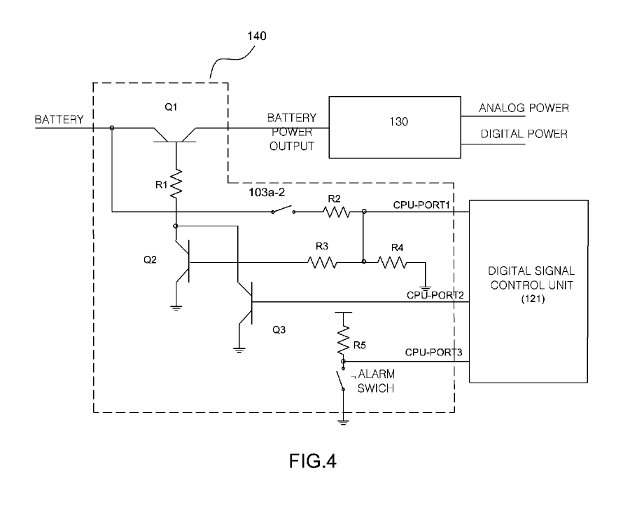

FIG. 4 is a diagram showing the switch unit 140 of the ultrasonic underwater pager according to an embodiment of the present invention. Referring to FIG. 4, the switch unit 140 is a circuit for completely blocking power supplied by the battery 110 when the ultrasonic underwater pager is not being operated.

As power is initially supplied in the state in which the reed switch 103a-2 is switched off, a transistor Q1, a transistor Q2, and a transistor Q3 are turned off, so that current does not flow and thus power is not output.

Thereafter, when the reed switch 103a-2 is switched on, current flows through a resistor R2, and the transistor Q2 is turned on, so that current flows through a resistor R1, and the transistor Q1 is turned on, with the result that power starts to flow and is then output.

In this case, when a digital signal is applied to a terminal CPU-ON by the digital signal control unit 121, the transistor Q3 is turned on, so that the transistor Q1 is continuously maintained in the ON state even if the reed switch 103a-2 is switched off.

This circuit is advantageous in that it enables the number of switches because the ON and OFF operations of the reed switch 103a-2 can be read at a terminal CPU-PORT connected to the digital signal control unit 121. In particular, when there is a need to prevent water from flowing into the underwater pager according to the present invention, it is very preferable to reduce the number of switches from the standpoint of hardware configuration.

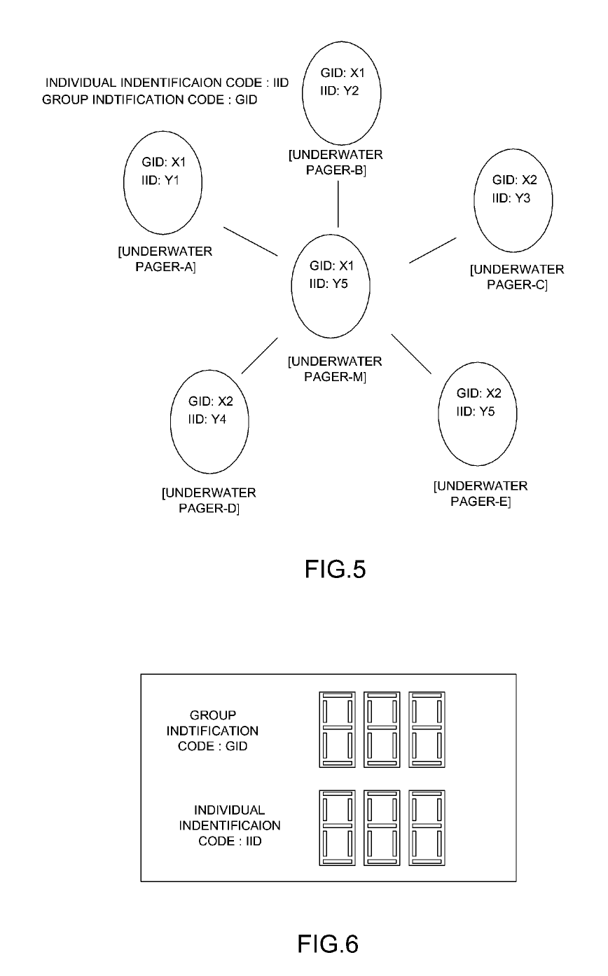

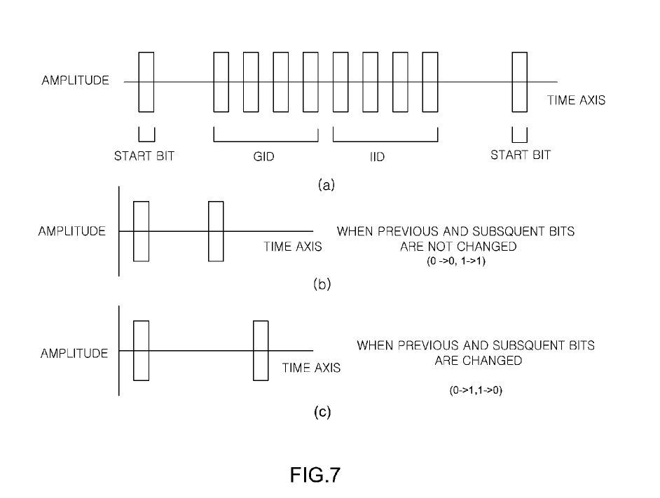

FIG. 5 is a conceptual diagram showing an operation using a plurality of ultrasonic underwater pagers according to an embodiment of the present invention, and FIG. 6 is a diagram showing examples of identification codes used in the ultrasonic underwater pager according to the present invention. FIG. 7 is a diagram showing an example of the digital information representation system of the ultrasonic underwater pager according to an embodiment of the present invention.

Referring to FIGS. 5 and 6, each of ultrasonic underwater pagers 100A, 100B, 100C, 100D, 100E, and 100M can set a group identification code (GID) and an individual identification code (IID), and is designated to assign its GID and IID to a transmission signal. When a reception signal is received, the digital signal control unit 121 can identify the group identification code (GID) and the individual identification code (IID) of the reception signal, as described above. Further, such an ultrasonic pager can be discriminated from a specific device within each relevant group.

In more detail, as shown in FIG. 5, if it is assumed that six ultrasonic underwater pagers are present, the ultrasonic underwater pager M 100M can transmit or receive signals simultaneously with the ultrasonic underwater pager A 100A and the ultrasonic underwater pager B 100B which have the same group identification code (GID: X1) as the underwater pager M 100M. Further, the ultrasonic underwater pager M 100M can individually transmit or receive signals to or from the ultrasonic underwater pager C 100C, the ultrasonic underwater pager D 100D, or the underwater pager E 100E which have a group identification code (GID: X2) different from that of the underwater pager M 100M.

In this embodiment, 3 bits have been used for a group identification code and an individual identification code, but more than 3 bits can also be used to implement the identification code according to the scale of groups and individual persons.

Further, each ultrasonic underwater pager 100 is configured such that a time information reception module is additionally installed in the digital signal control unit 121 and thus a time indication function can be assigned.

The digital information representation system of the ultrasonic underwater pager, related to the transmission signal of FIG. 7A, is described below. That is, a transmission signal to be output from the ultrasonic transducer 101 may be composed of a start bit of 1 bit, an individual identification code (IID) of 4 bits, and a group identification code (GID) of 4 bits.

Further, a bit representation method is described below. That is, information can be represented in such a way that time is further lengthened in the case where previous and subsequent bits are changed, as shown in FIG. 7C, that is, when ‘0’→‘1’ or ‘1’→‘0’, compared to the case where previous and subsequent bits are not changed, as shown in FIG. 7B, that is, when ‘0’→‘0’ or ‘1’→‘1’. It is also possible to set a bit representation method in the opposite manner. Of course, in this case, an initial value must be set in advance, and this setting may be made when software is implemented.

The present invention may be implemented as computer-readable code on a computer-readable storage medium. The computer-readable storage medium includes all types of recording devices on which data capable of being read by a computer system is stored.

Examples of the computer-readable storage medium may be Read Only Memory (ROM), Random Access Memory (RAM), Compact Disc-ROM (CD-ROM), a magnetic tape, a floppy disc, an optical data storage device, etc. Further, the storage medium may also include a carrier wave form (for example, the case of it being provided over the Internet).

Furthermore, the computer-readable storage medium may be distributed across computer systems connected to each other over a network, and the computer-readable code may be stored and executed in the computer systems in a distributed manner. Furthermore, the functional programs, codes, and code segments for implementing the present invention can be easily deduced by programmers in the art to which the present invention pertains.

As described above, the ultrasonic underwater pager according to an embodiment of the present invention is advantageous in that the structure thereof is simplified so that the pager is watertight and can be used underwater without a hole being formed in the outer wall of a casing, and in that the propagation of ultrasonic waves is facilitated.

Further, the ultrasonic underwater pager according to another embodiment of the present invention is advantageous in that it assigns a group identification code and an individual identification code under the water, thus transmitting or receiving signals to or from a specific group or a specific person.

Furthermore, the ultrasonic underwater pager according to a further embodiment of the present invention is advantageous in that it assigns a group identification code and an individual identification code, which correspond to an independent address, to a transmission signal, thus transmitting or receiving meaningful signals between a plurality of users and a specific user who are equipped with underwater pagers underwater.

Furthermore, the ultrasonic underwater pager according to yet another embodiment of the present invention is advantageous in that a warning related to the results of communication can be provided in the form of sound or light using a buzzer, and in that power switching can be performed using a magnetic phenomenon between a magnet and a reed switch.

As described above, although the preferred embodiments of the present invention have been disclosed in the present specification and drawings for illustrative purposes and specific terms have been used, these terms are only intended to easily describe the technical contents of the present invention and help the understanding of the present invention, and are not intended to limit the scope of the present invention. Those skilled in the art will appreciate that various modifications, additions and substitutions, as well as those embodiments, are possible, without departing from the scope and spirit of the invention.

What is claimed is:

1. An ultrasonic underwater pager, comprising:
an ultrasonic transducer for transmitting or receiving ultrasonic signals;
an electronic circuit unit for generating an ultrasonic signal having a predetermined address and analyzing a received ultrasonic signal;
a switch unit switched using a magnetic phenomenon and configured to supply power to the electronic circuit unit and transmit external commands to the electronic circuit unit;
a watertight casing configured such that the ultrasonic transducer, the electronic circuit unit, and the switch unit are installed in the watertight casing, the ultrasonic transducer being installed in a raised position in the watertight casing using a molding process, thus facilitating propagation of ultrasonic waves; and
a magnet attached to a rubber cover connected to an outside of the watertight casing, and configured to switch on/off the switch unit using a magnetic phenomenon.

2. The ultrasonic underwater pager according to claim 1, wherein the electronic circuit unit comprises:
a digital signal control unit for generating a transmission signal and analyzing a received signal;
a switching driving unit for receiving a switching signal and a transmission trigger signal from the digital signal control unit, and performing low-current switching on an initially generated transmission signal;
a high-current switching unit for performing high-current switching on the low-current switched transmission signal;
a matching unit for increasing switching efficiency of the high-current switching unit and enabling maximum power to be transferred;
a diode coupling unit for transferring the transmission signal which has been high-current switched by the high-current switching unit to the ultrasonic transducer, and receiving the ultrasonic signal from the ultrasonic transducer;
a received signal amplification unit for filtering and amplifying the signal received from the diode coupling unit;
an envelope detector for detecting an envelope of the amplified signal; and
a power control circuit for controlling supply of external power.

3. The ultrasonic underwater pager according to claim 2, wherein the switch unit comprises:
a reed switch switched according to a location of the magnet; and
a switch input circuit for allowing current to flow and power to be output when the reed switch is switched on, and for allowing current to continuously flow and power to be output even if the reed switch is switched off when a digital signal is applied by the digital signal control unit.

4. The ultrasonic underwater pager according to claim 3, wherein the address comprises:
a group identification code required to identify a group and composed of predetermined bits; and
an individual identification code required to identify each individual device and composed of predetermined bits.

5. The ultrasonic underwater pager according to claim 1, further comprising an information display window for displaying transmission/reception addresses, an alarm, and states of the electronic circuit unit.

6. The ultrasonic underwater pager according to claim 1, further comprising a connection belt formed on both side surfaces of the watertight casing and used to allow the ultrasonic underwater pager to be attached to a human body or an object.
